(19) United States
(12) Patent Application Publication
(10) Pub. No.: US 2007/0218904 A1
(43) Pub. Date: Sep. 20, 2007

(54) System and method for allocating frequency resource in multi-cell communication system

(75) Inventors: Dae-Young Park, Seoul (KR); Cheol-Woo You, Seoul (KR); Seung-Young Park, Yongin-si (KR); Sang-Boh Yun, Seongnam-si (KR); Yung-Soo Kim, Seongnam (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/715,167

(22) Filed: Mar. 7, 2007

(30) Foreign Application Priority Data
Mar. 7, 2006 (KR) 2006-0021351

(51) Int. Cl. H04Q 7/20

(52) U.S. Cl. 455/436

(57) ABSTRACT

Disclosed is a method for efficiently allocating resources in a multi-cell communication system. The method includes feeding back, by a mobile station to a base station, Modulation and Coding Scheme (MCSs) corresponding to loading factors; calculating, by the base station, efficient data rates corresponding to the MCSs fedback from the mobile station; allocating, by the base station, a loading factor according to the MCSs to the mobile station; and allocating resources to the mobile station according to the loading factor.

### PRIORITY

This application claims priority under 35 U.S.C. 119(a) to an application filed in the Korean Intellectual Property Office on Mar. 7, 2006 and assigned Serial No. 2006-21351, the contents of which are incorporated herein by reference.

### BACKGROUND OF THE INVENTION

1. Field of the Invention

The present invention relates to a multi-cell communication system, and more particularly to a system and method for allocating resources in a multi-cell communication system.

2. Description of the Related Art

In general, a multi-cell communication system suffers from inter-cell interference (ICI), because multiple cells constituting the multi-cell communication system use limited resources, for example, frequency resources, code resources and time slot resources on a division basis and some different cells reuse the same resources. When different cells reuse the frequency resources, code resources and time slot resources in the multi-cell communication system, the performance of the multi-cell communication system is degraded due to the ICI, but it still benefits from increased total capacity.

Because frequency resources are reused within the multi-cell communication system, it is then possible to compute a frequency reuse factor. The frequency reuse factor “K” will now be described.

In order to reuse frequency resources with reduced ICI in the multi-cell communication system in which the cells use a frequency band on a division basis, the frequency band is divided into K sub-frequency bands, where K denotes the frequency reuse factor. The K sub-frequency bands are allocated to K cells including a serving cell among the multiple cells, and the K sub-frequency bands are reused in some of the remaining cells other than the K cells, taking into account the interference to or from other cells.

As the frequency reuse rate is lower, that is, as the frequency reuse factor exceeds 1 (K>1), ICI decreases but the amount of frequency resources available in a cell also decreases, thereby causing a reduction in the total capacity of the multi-cell communication system. In contrast, when the frequency reuse factor is 1 (K=1), i.e., when all cells constituting the multi-cell communication system use the same frequency band, ICI increases but the amount of frequency resources available in a cell also increases, thereby causing an increase in the total capacity of the multi-cell communication system.

Meanwhile, a multi-cell communication system (hereinafter “CDMA multi-cell communication system”) using Code Division Multiple Access (CDMA) scheme allocates a unique scrambling code to each cell constituting the CDMA multi-cell communication system so as to distinguish each of the cells. Due to the use of the scrambling codes, the CDMA multi-cell communication system minimizes ICI, and all cells constituting the CDMA multi-cell communication system reuse the frequency band of the CDMA multi-cell communication system, thereby maintaining the frequency reuse factor of 1.

When the frequency reuse factor is maintained at 1 in the CDMA multi-cell communication system, ICI may be increased as compared to when the frequency reuse factor is set higher than 1, however, efficiency of the frequency resources may also increase, thereby contributing to noticeable improvements in total system capacity. In addition, the CDMA multi-cell communication system allocates a unique code to each of subscriber stations (SSs) in order to reduce interference between user signals of the SSs located in each of the cells thereof. Therefore, each of the SSs spreads and transmits its user signal over the frequency band by using the code uniquely allocated thereto. The code allocated to each of the SSs is an orthogonal code, and can minimize the interference between the SSs.

In the CDMA multi-cell communication system, an increase in number of SSs per cell increases the interference between the SSs or the ICI, which causes a restriction of the total system capacity. However, if the number of SSs per cell approaches a certain range within the available number of SSs accommodated by each cell, the increase in interference between the SSs or ICI does not affect the total system capacity and instead, increases efficiency of the frequency resources, thereby contributing to an increase in the system capacity.

However, the efficiency of the CDMA multi-cell communication system significantly decreases when the frequency band is spread because the system transmits high-speed data. A detailed description thereof follows. When the frequency band is spread, (1) the code length must increase, (2) the chip period must decrease, (3) a plurality of multipath components must be acquired, (4) the system performance seriously degrades due to an increase in interference between the multipath components, and (5) the system implementation complexity significantly increases.

First, a conventional resource allocation method will be schematically described.

FIG. 1A shows an example of a resource allocation method when the traffic load is ⅓ of total capacity. That is, FIG. 1A shows a case in which mobile stations (e.g., Node B1, Node B2 and Node B3) are allocated sub-bands (i.e., sub-band A, sub-band B and sub-band C), respectively.

FIG. 1B shows an example of a resource allocation method when the traffic load is ⅔ of total capacity. That is, FIG. 1B shows a case in which each of the mobile stations (e.g., Node B1, Node B2 and Node B3) is allocated two sub-bands (i.e., sub-bands A and B, sub-bands A and C or sub-bands B and C), respectively.

FIGS. 1A and 1B show conventional resource allocation methods, in which mobile stations are arranged according to required transmit powers thereof, and a mobile station requiring a higher transmit power is first allocated a higher priority sub-band.

In this case, there is a problem in that it is necessary to feedback information about power required for transmission according to each mobile station. Also, according to the conventional resource allocation method, although resources are first allocated to a mobile station having a poor channel, there is a limitation in improving the throughput performance of the entire system because each mobile station must feedback information about required power, as described above.

Meanwhile, the 4^{th} generation (4G) communication system, which is the next generation communication system, is being developed to provide users with services having various high data rate Qualities-of-Service (QoS). In particular, active research in high-speed service that guarantees the mobility and QoS for a Broadband Wireless Access (BWA) communication system such as a wireless Local Area Network (LAN) system and a wireless Metropolitan Area Network (MAN) system is being conducted.

In the 4 G communication system, Orthogonal Frequency Division Multiplexing (OFDM)/Orthogonal Frequency Division Multiple Access (OFDMA) scheme is being actively studied as a useful scheme for high data rate in wire/wireless channels. OFDM/OFDMA is a data transmission scheme using multiple carriers; OFDM/OFDMA is a type of Multi-Carrier Modulation (MCM) scheme that converts a serial input symbol stream into parallel symbols and modulates each of the parallel symbols into a plurality of sub-carriers having mutual orthogonality before transmission. A multi-cell communication system using the OFDM/OFDMA scheme will be referred to as an “OFDM/OFDMA multi-cell communication system.”

The 4G-communication system needs broadband spectrum resources in order to provide high-speed high-quality wireless multimedia service. However, the use of the broadband spectrum resources increases the fading effect in a wireless transmission line due to multipath propagation, and causes frequency selective fading effect even in a transmission band. Therefore, the 4G-communication system tends to actively utilize the OFDM/OFDMA scheme in order to provide high-speed wireless multimedia service, because the OFDM/OFDMA scheme, which is robust against frequency selective fading as compared with CDMA, has relatively higher gain.

A typical communication system using the OFDM/OFDMA scheme to support a broadband transmission network for physical channels, like the 4 G communication system, includes the Institute of Electrical and Electronics Engineers (IEEE) 802.16 communication system. The IEEE 802.16 communication system enables high-speed data transmission by using multiple sub-carriers in transmitting signals through a physical channel. The IEEE 802.16 communication system applies the OFDM/OFDMA scheme to the wireless MAN system.

Meanwhile, the IEEE 802.16 communication system uses various schemes in order to support high-speed data transmission. For example, a representative scheme used in IEEE 802.16 is Adaptive Modulation and Coding (AMC) scheme. AMC refers to a data transmission scheme for adaptively selecting a modulation scheme and a coding scheme depending on the channel state between a cell, i.e., a base station (BS), and a mobile station (MS), thereby improving the usage efficiency of the entire cell.

AMC has a plurality of modulation schemes and a plurality of coding schemes. AMC modulates and codes channel signals with an appropriate combination of the modulation schemes and the coding schemes. Generally, each combination of the modulation schemes and the coding schemes is referred to as a Modulation and Coding Scheme (MCS), and a plurality of MCSs with level 1 to level N are defined by the number of the MCSs. That is, the MCS scheme adaptively determines one of the MCS levels depending on a channel state between a BS and an MS wirelessly connected to the BS, thereby improving the entire system efficiency of the BS.

In order to use various high-speed data transmission schemes such as AMC in the IEEE 802.16 communication system, an MS must feedback the channel state, i.e., Channel Quality Information (CQI), of a downlink to a BS to which the MS belongs.

Next, a description will be made of an operation in which an MS transmits its own CQI to a BS, to which the MS belongs, through a CQI channel in the IEEE 802.16 communication system.

First, a BS transmits to an MS information (i.e., a CQI channel index) on a CQI channel, which is allocated to the MS, through a CQI channel allocation message. Upon receiving the CQI channel allocation message, the MS detects the index of the CQI channel allocated thereto, generates its own downlink CQI with a predetermined number of bits, for example, 6 bits, and feeds back the generated CQI to the BS.

The IEEE 802.16 communication system, because it is based on the MAN communication system, has very low mobility or no mobility, like communication between base stations (BSs), and performs communication using a point-to-point scheme or a point-to-multipoint scheme other than the concept of the multi-cell communication system. Therefore, the IEEE 802.16 communication system cannot be applied to the general multi-cell communication system. Although intensive research in applying mobility to the IEEE 802.16 communication system is now being conducted; there is no proposed scheme for minimizing ICI, taking into account the multi-cell environment and the frequency reuse factor.

Accordingly, there is a need for a method for minimizing ICI while increasing the efficiency of frequency resources by applying the frequency reuse factor 1 in the multi-cell communication system as described above. In addition, there is a need for a CQI transmission/reception method for improving the efficiency of resources.

Furthermore, feeding back information about power required for transmission according to each mobile station is a problem in the prior art; to solve such problem, the present invention allocates a frequency loading factor suitable for each mobile station, based on MCSs fedback from the mobile station. Also, the present invention uses a fractional reuse scheme without a specific coordination according to each cell, in which a CQI feedback and loading factor allocation method is proposed in using the fractional reuse scheme. Through the present invention as describe above, it is possible to efficiently manage inter-cell interference (ICI) in the multi-cell communication system.

### SUMMARY OF THE INVENTION

Accordingly, the present invention solves the above-mentioned problems occurring in the prior art, and provides a solution for efficiently managing the loading factor of each mobile station (MS) in a multi-cell communication system.

Also, the present invention provides a solution for allocating to each MS a frequency loading factor suitable for the MS in a multi-cell communication system.

Also, the present invention provides a solution for determining the CQI feedback and loading factor for supporting a frequency fractional loading, and efficiently allocating resources based on the determination in a multi-cell communication system.

In accordance with an aspect of the present invention, there is provided a method for allocating resources in a multi-cell communication system, the method includes, feeding back, by a mobile station, Modulation and Coding Scheme (MCSs) corresponding to loading factors to a base station; calculating, by the base station, efficient data rates corresponding to the MCSs fedback from the mobile station; allocating, by the base station, a loading factor according to the MCSs to the mobile station; and allocating resources to the mobile station according to the loading factor.

In accordance with another aspect of the present invention, there is provided a system for allocating resources in a multi-cell communication system, the system includes a mobile station for periodically or non-periodically feeding back Modulation and Coding Scheme (MCSs) corresponding to loading factors to a base station; and a base station for transmitting a reference signal according to the loading factors to each mobile station, calculating efficient data rates corresponding to the MCSs fedback from the mobile station, selecting a loading factor based on the calculated effective data rates, and allocating resources to the mobile station according to the loading factor.

### BRIEF DESCRIPTION OF THE DRAWINGS

The above and other aspects, features and advantages of the present invention will be more apparent from the following detailed description taken in conjunction with the accompanying drawings, in which:

FIGS. 1A and 1B illustrate methods of allocating resources according to traffic loads in a conventional communication system;

FIGS. 2A to 2F illustrate fractional loading according to the present invention;

FIG. 3 shows a reference packet for measurement of CQI according to the present invention;

FIGS. 4A to 4F are plots of the reference signal for measurement of CQI according to each loading factor based on an embodiment of the present invention; and

FIG. 5 is a flowchart for a resource allocation procedure using loading factors according to the present invention.

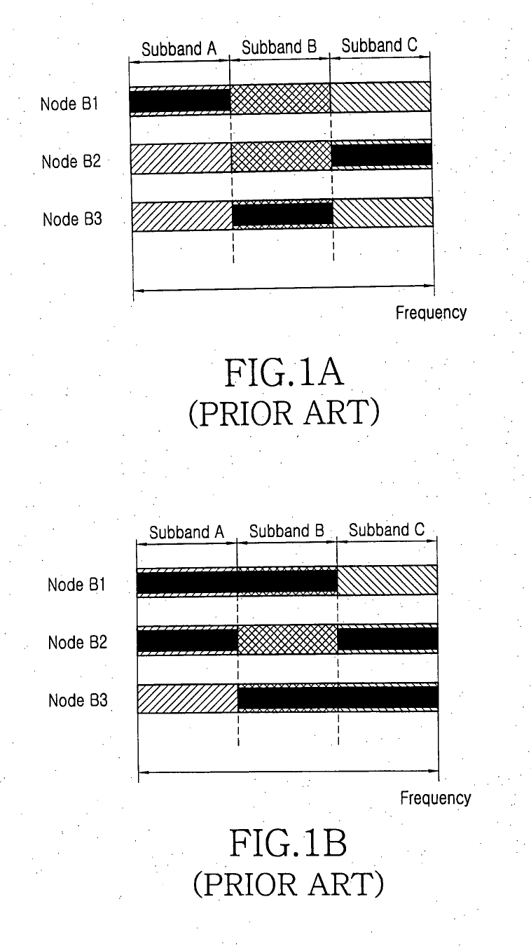

### DETAILED DESCRIPTION OF THE EXEMPLARY EMBODIMENT

Hereinafter, one exemplary embodiment according to the present invention will be described with reference to the accompanying drawings. In the following description, detailed description of known functions and configurations will be omitted when it may obscure the subject matter of the present invention.

The configurations described in the specification and depicted in the figures are represent most preferred embodiments of the present invention, and do not show all of the technical aspects of the present invention. So, it should be understood by an artisan of ordinary skill in the art that there might be various equivalents and modifications that may replace them.

The present invention provides a method for Channel Quality Information (CQI) feedback and inter-cell interference (ICI) management in a multi-cell communication system. Particularly, the present invention provides a method for transmitting a reference signal and feeding back a Modulation and Coding Scheme (MCS) according to a loading factor.

According to the present invention, each mobile station (MS) feeds back to a base station (BS) an MCS corresponding to each loading factor, and the BS determines the loading factor for each MS based on MCSs fedback from each MS and allocates resources according to the loading factor.

To this end, the present invention provides a method for feeding back CQI and determining the loading factor that can support a frequency fractional loading. Also, the present invention provides an MS, which is designed to feedback an MCS according to the loading factor. In addition, the present invention proposes a BS, which is designed for allocating loading factors to MSs based on information fedback from the MSs. Also, the present invention provides a method for efficiently managing loading factors of MSs according to channel information of each MS and the importance of each loading factor.

An exemplary embodiment of the present invention will now be described.

First, according to an embodiment of the present invention, the frequency loading factor refers to a ratio of the number of used subcarriers to the total number of available subcarriers, and may be expressed as the following Equation (1).

$$LF = \frac{{n}_{used}}{{N}_{tot}} \qquad ( 1 )$$

In Equation 1, “LF” represents a loading factor, “Nₜₒₜ” represents the total number of available subcarriers, and “N_{used}” represents the number of used subcarriers among the total subcarriers.

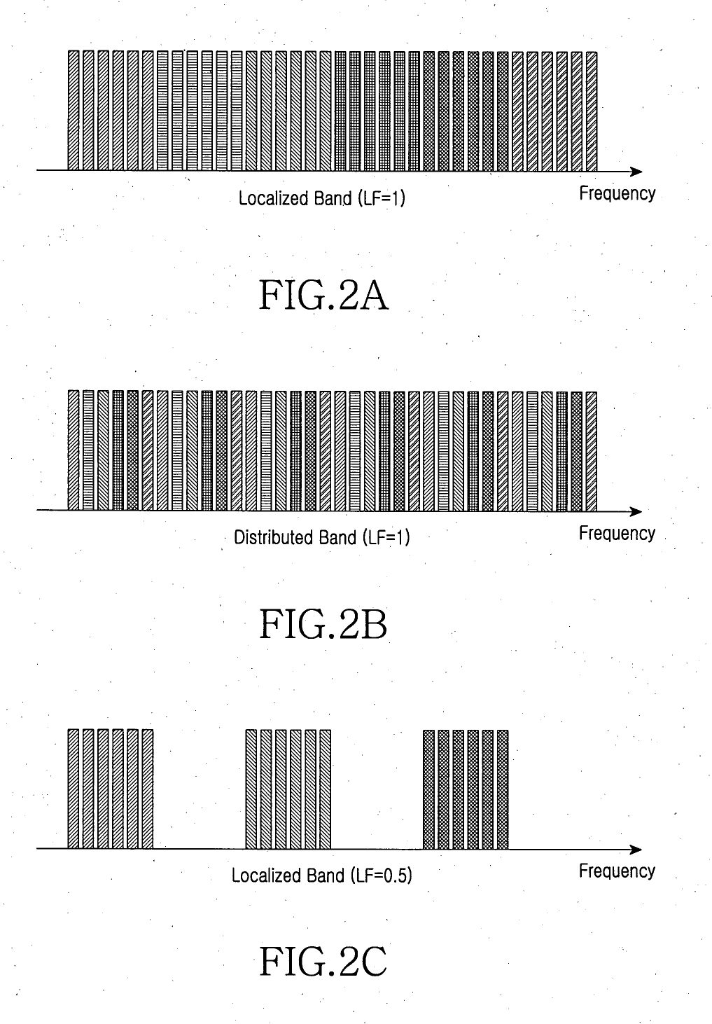

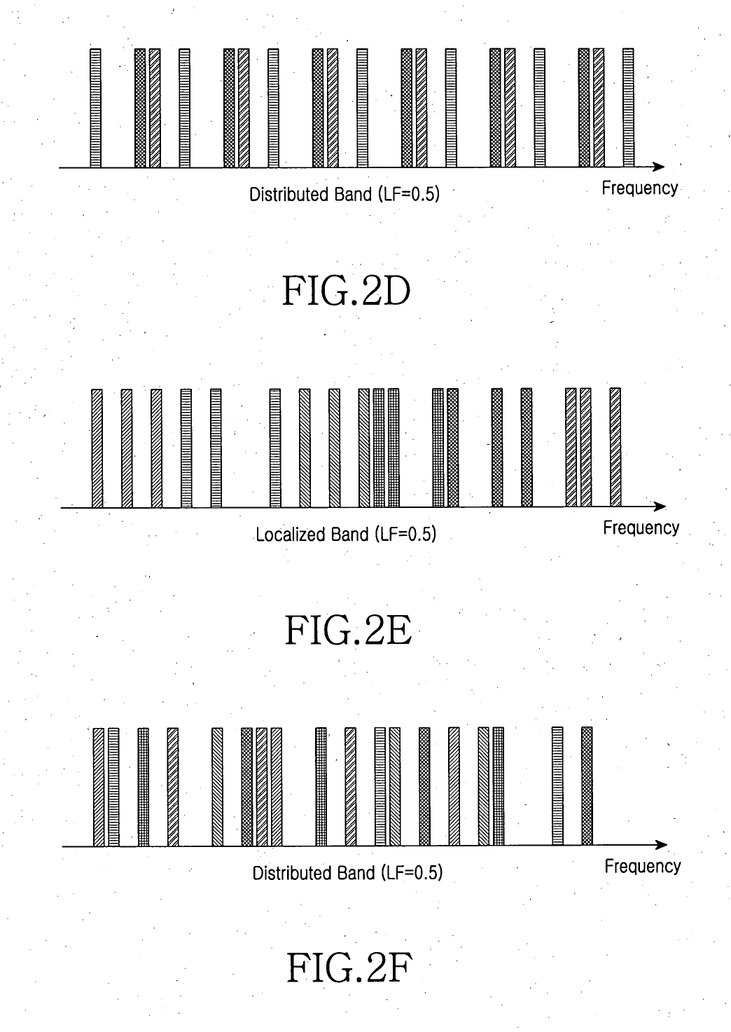

A fractional loading based on an embodiment of the present invention will now be described with reference to FIGS. 2A to 2F.

FIGS. 2A to 2F illustrate fractional loading in a communication system using a localized frequency division multiple access (FDMA)/distributed FDMA scheme. FIG. 2A shows a localized band and FIG. 2B shows a distributed band.

FIGS. 2A and 2B show a case in which all subcarriers are used, that is, a case in which the loading factor has a value of “1” (i.e., LF=1). Referring to FIGS. 2A and 2B, all subcarriers are selected for transmission, and one subchannel includes subcarriers having the same hatching and is transmitted from one base station to the same user, that is, to the same mobile station. FIGS. 2C and 2D show a case in which some (e.g., half) of the total subcarriers are used, that is, a case in which the loading factor has a value of “0.5” (i.e., LF=0.5). Referring to FIGS. 2C and 2D, some of the subcarriers are not selected for transmission. FIG. 2C shows a localized band and FIG. 2D shows a distributed band.

FIGS. 2E and 2F show a case in which some (e.g., half) of the total subcarriers are used, that is, a case in which the loading factor has a value of “0.5” (i.e., LF=0.5). Referring to FIGS. 2E and 2F, some portion of subcarriers in one subchannel are not used for transmission. FIG. 2E shows a localized band and FIG. 2F shows a distributed band.

As described above, subcarriers used for transmission and subcarriers not used for transmission are divided through the fractional loading, in which such a division is performed by a base station or mobile station.

It should be clearly understood that when the division is performed by a base station, frequency bands corresponding to each loading factor may coincide or may differ between base stations. For example, while a first cell has a loading factor of 0.5 for a specific band, a neighboring cell, e.g., a second cell, may have a loading factor of 0.5 or a loading factor of a different value (e.g., 0.75) for the specific band. Preferably, the loading factor for each frequency band is maintained during a predetermined period. According to an embodiment of the present invention, it is possible to control inter-cell interference, which exerts an effect to adjacent cells, through the fractional loading.

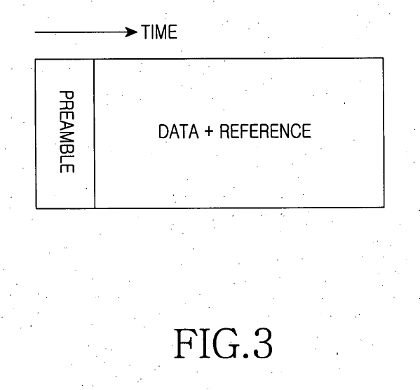

A reference signal according to an embodiment of the present invention will now be described with reference to FIG. 3.

First, according to another exemplary embodiment of the present invention, a base station transmits the reference signal, which will now be described with reference to FIG. 3. Referring to FIG. 3, it can be understood that the reference signal according to an embodiment of the present invention is multiplexed with preamble, data, etc. in the time domain. That is, the reference signal has a relation with a data region. Preferably, such a reference signal is transmitted at a predetermined interval. However, it is not necessary to transmit the reference signal every transmission time interval (TTI).

Also, it is preferred that the reference signal uses patterns defined in consideration of loading factors as described above, the transmission interval and the patterns corresponding to the loading factors are defined in advance as system parameters. In addition, adjacent cells may transmit the reference signal in the same time/frequency domain.

Meanwhile, each mobile station measures CQI according to each loading factor, by using the reference signal transmitted from the base station as described above. The reference signal for measurement of CQI according to each loading factor will be described.

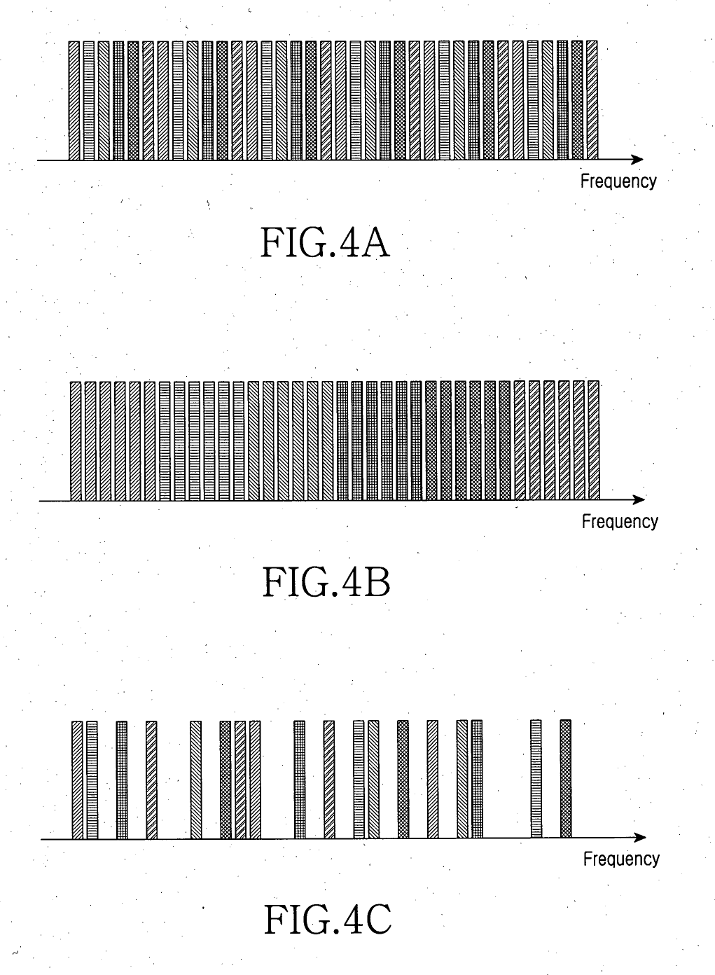

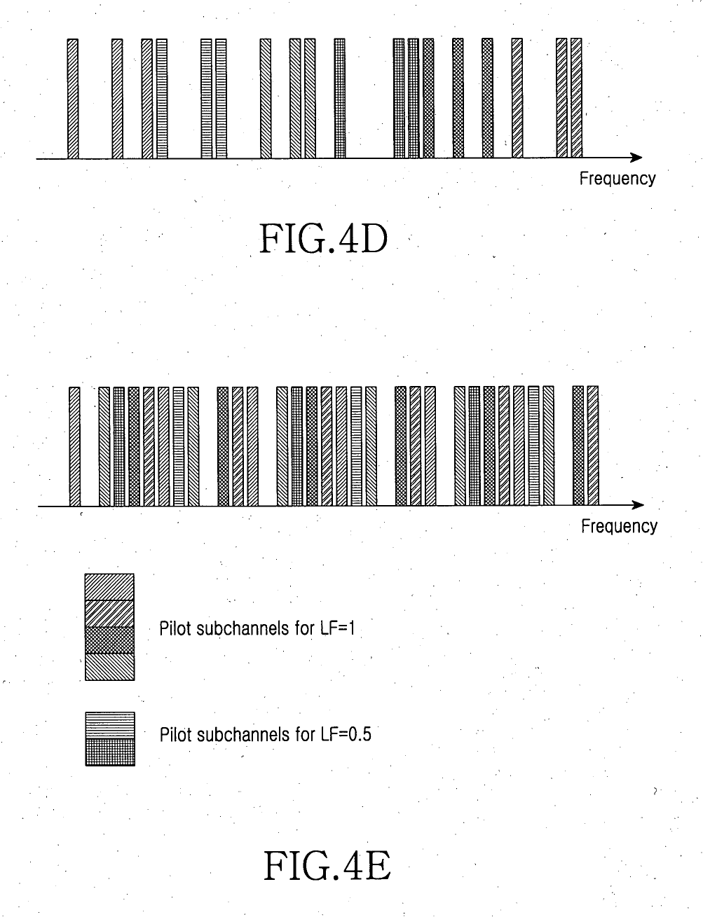

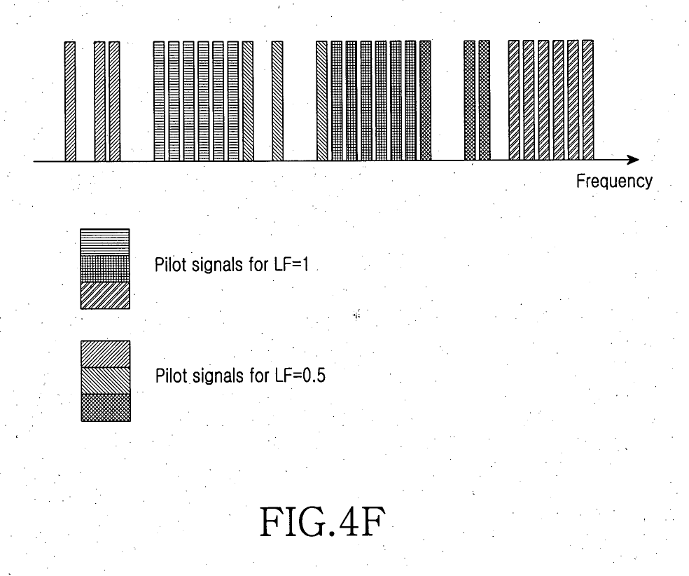

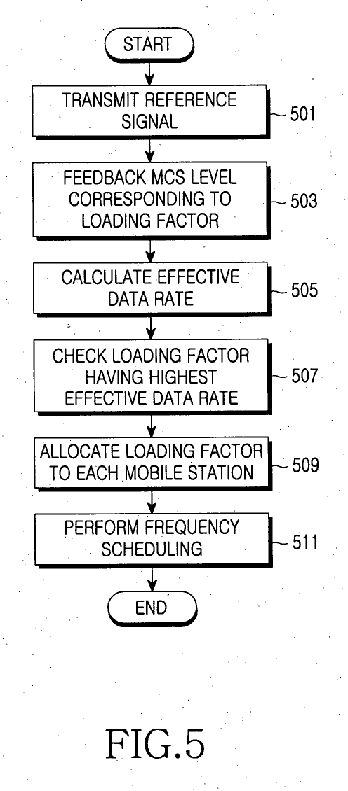

First, FIGS. 4A to 4D show reference signal plots for measurement of CQI when there is a signal loading factor. FIGS. 4A and 4B show reference signals for measurement of CQI when the loading factor has a value of “1” (i.e., LF=1), and FIGS. 4C and 4D show reference signals for measurement of CQI when the loading factor has a value of “0.5” (i.e., LF=0.5). As described above, each mobile station can measure CQI according to each loading factor by using a corresponding reference signal.

FIGS. 4E and 4F show reference signal plots for measurement of CQI when there is a plurality of loading factors. Referring to FIGS. 4E and 4F, it can be understood that reference signals for a plurality of LFs exist at the same time on the same frequency band. A reference signal with which channel measurement for the plurality of loading factors is possible will be described in detail.

First, every base station uses a reference subchannel having the same configuration, and is set to periodically generate a reference subchannel for a specific loading factor. For example, when a loading factor of “1” (LF=1) and a loading factor of “0.5” (LF=0.5) are supported, every base station may be set to use a pilot for the loading factor of “1” in odd-numbered subchannels, and to use a pilot for the loading factor of “0.5” in even-numbered subchannels.

Also, each subchannel having a loading factor less than “1” (i.e., LF<1) may be configured by pseudo-randomly selecting subcarriers in a pattern specified in the base station or cell. For example, while a first cell configures a reference subchannel having a loading factor of 0.5 (i.e., LF=0.5) by selecting half of available subcarriers based on a first pattern appointed with mobile stations, an adjacent cell (e.g., a second cell) may configure a reference subchannel having a loading factor of 0.5 (i.e., LF=0.5) by selecting half of available subcarriers based on a pattern other than the first pattern. Each mobile station can measure the channel quality for each loading factor by measuring the qualities of subchannels corresponding to the loading factors as described above.

Meanwhile, in the case of a localized band, when a reference signal simultaneously supporting a plurality of loading factors is configured, it is preferable that an interval is set in consideration of a coherent bandwidth. For example, when four loading factors are supported, a reference subchannel corresponding to a specific loading factor is set in an interval of four localized bands. In this case, in order to prevent occurrence of a problem in which a channel corresponding to a relevant loading factor cannot be measured over all bands due to the coherent bandwidth less than the width of the four localized bands; the interval is controlled such that the coherent bandwidth is greater than the interval of the reference subchannel, or a plurality of reference signals are configured so as to measure the MCS of each loading factor over all bands.

An effective data rate (EDR) according to an exemplary embodiment of the present invention will be described. EDR according to an embodiment of the present invention may be expressed as Equation (2).
EDRᵢ=aᵢ×MCSᵢ×LFᵢ (2)

In Equation 2, “EDRᵢ” represents an effective data rate, “i” represents a loading factor index, “LFᵢ” represents an i^{th} loading factor, “aᵢ” represents a weight corresponding to the LFᵢ, and “MCSᵢ” represents an MCS corresponding to the LFᵢ.

First, as described above, a mobile station measures MCSᵢ by using the aforementioned reference signal. In this case, the preference or priority of a corresponding loading factor region is reflected in the weight. For example, when a base station wants to allocate resources of a specific loading factor region first of all, a weight higher than any other loading factor regions is used for the specific loading factor region.

Next, each mobile station randomly transmits an MCS level, i.e., the MCSᵢ, corresponding to each loading factor to the base station. Then, the base station calculates the EDR according to the MCSᵢ reported from each mobile station based on Equation 2, and then allocates each mobile station a loading factor having the highest EDR first of all. Next, the base station performs a frequency scheduling in consideration of the loading factor allocated to each mobile station.

Preferably, a base station controller, for example, a radio network controller (RNC), which has a superior position to the base station, controls the size of each loading factor region at a predetermined interval with respect to all or some base stations based on the MCSᵢ collected as described above.

A feedback method of a mobile station according to an embodiment of the present invention will be described.

A mobile station according to an exemplary embodiment of the present invention randomly transmits an MCS according to a loading factor or an EDR obtained through Equation 2 to the base station, by using a reference signal transmitted from the base station.

First, the cases in which the mobile station feedbacks the MCS will now be described.

1) Transmitting MCSᵢ for all loading factors at once:

For example, the mobile station may transmit MCSs 0.5, 2 and 3 corresponding to loading factors 1, 0.5 and 0.25 (i.e., LF=1, 0.5 and 0.25), respectively, at once.

2) Transmitting MCSᵢ for loading factors one by one:

For example, the mobile station may transmit MCSs 0.5, 2 and 3 corresponding to loading factors 1, 0.5 and 0.25 (i.e., LF=1, 0.5 and 0.25), respectively, one by one.

3) Transmitting a predetermined number of MCSᵢ (e.g., x (x≧1) number of MCSᵢ) in the most preferable sequence either one by one or at once:

For example, the mobile station may transmit MCSs 2 and 0.5 corresponding to loading factors 0.5 and 1 (i.e., LF=0.5 and 1) either one by one or at once.

Next, the cases in which, the base station notifies the mobile station of weights corresponding to loading factors, e.g., the aᵢ as shown in Equation 2, when the mobile station directly calculates EDRs by using the weights and feedbacks the EDRs to the base station.

1) The mobile station may transmit EDRᵢ for all loading factors at once.

2) The mobile station may transmit EDRᵢ for loading factors one by one.

3) The mobile station may transmit a predetermined number of EDRᵢ (e.g., x (x≧1) number of EDRᵢ) in the most preferable sequence either one by one or at once.

First, a base station transmits reference signals according to loading factors to each mobile station in step 501, and then step 503 is performed. In step 503, each mobile station measures MCS levels corresponding to the loading factors by using the reference signals and randomly feedbacks the measured MCS levels to the base station, and then step 505 is performed.

In step 505, the base station calculates EDRs based on Equation 2 by using the MCSs, which have been fedback from the mobile stations in step 503, and then step 507 is performed. In step 507, the base station checks a loading factor having the highest value among the calculated EDRs, and then step 509 is performed.

In step 509, the base station first allocates loading factors having the highest EDR to each mobile station, and then proceeds to step 511, in which the base station performs a frequency scheduling in consideration of the loading factors allocated to the mobile stations.

Although it is not shown, it should be clearly understood that a base station controller, for example, an RNC, which has a superior position to the base station, controls the size of each loading factor region at a predetermined interval with respect to all or some base stations based on the MCS collected from each mobile station, as described above.

The exemplary embodiment of the present invention as described above will be described in more detail with reference to Table 1.

TABLE 1

| I | LFᵢ | aᵢ | MCSᵢ | EDR |
|---|---|---|---|---|
| 1 | 1 | 3 | 0.5 | 1.5 |
| 2 | 0.75 | 2 | 1 | 1.5 |
| 3 | 0.5 | 2 | 2 | 2 |
| 4 | 0.25 | 1 | 3 | 0.75 |

As shown in Table 1, a predetermined mobile station feeds back “0.5, 1, 2 and 3” as MCSᵢ corresponding to each loading factor “LFᵢ” to a base station. Then, the base station receives the MCSᵢ fedback from the mobile station, and calculates EDRs according to the MCSᵢ. As shown in Table 1, the mobile station is allocated a loading factor of 0.5 (LF=0.5) having the highest EDR value (i.e., EDR=2).

As described above, according to an exemplary embodiment of the present invention, a base station transmits reference signals according to loading factors, and then each mobile station measures MCSs according to loading factors by using the reference signals. In this case, each base station may be set to use subchannels having the same configuration and to periodically generate a subchannel for a specific loading factor.

In addition, according to an embodiment of the present invention, a mobile station. randomly feedbacks MCS levels corresponding to loading factors, as described above, to the base station. Then, the base station calculates EDRs according to MCSs fedback from the mobile station, and determines a loading factor suitable for the mobile station based on the calculated EDRs. Thereafter, the base station can efficiently manage and allocate resources based on the loading factor allocated to the mobile station.

As described above, the system and method for allocating resources in a multi-cell communication system according to an embodiment of the present invention has an advantage in that it can efficiently calculate the loading factor of a mobile station, based on channel information of the mobile station and importance of each loading factor. Also, the resource allocation system and method according to the present invention can reduce inter-cell interference in a multi-cell communication system through efficient management of loading factors. In addition, the resource allocation system and method according to the present invention can increase the throughput of the entire system through efficient resource allocation based on loading factors.

While the present invention has been shown and described with reference to certain exemplary embodiments thereof, it will be understood by those skilled in the art that various changes in form and details may be made therein without departing from the spirit and scope of the invention as further defined by the appended claims. Accordingly, the scope of the invention is neither limited by the above embodiments nor by the claims or equivalents thereof.

What is claimed is:

1. A method for allocating resources in a multi-cell communication system, the method comprising the steps of:
feeding back, by a mobile station, Modulation and Coding Scheme (MCSs) corresponding to loading factors to a base station;
calculating, by the base station, efficient data rates corresponding to the MCSs fedback from the mobile station;
allocating, by the base station, a loading factor according to the MCSs to the mobile station; and
allocating resources to the mobile station according to the loading factor.

2. The method as claimed in claim 1, wherein the step of feeding back the MCSs comprises:
transmitting to each mobile station, by the base station, a reference signal according to the loading factors; and
measuring and feeding back, by the mobile station, MCSs corresponding to the loading factors by using the reference signal.

3. The method as claimed in claim 2, wherein the reference signal comprises a signal for the mobile station to measure channel qualities according to the loading factors.

4. The method as claimed in claim 2, wherein the reference signal is transmitted in a pattern defined according to the loading factors, and a transmission interval of the reference signal and the pattern according to the loading factors are defined in the system in advance.

5. The method as claimed in claim 2, wherein each base station transmits the reference signal in an equal time/frequency domain.

6. The method as claimed in claim 2, wherein the reference signal simultaneously exists together with the loading factors in the same frequency.

7. The method as claimed in claim 1, wherein the mobile station randomly feeds back the MCSs to the base station.

8. The method as claimed in claim 1, wherein the loading factor refers to a ratio of a number of used subcarriers to the total number of subcarriers, and is expressed as:
$$LF = \frac{{n}_{used}}{{N}_{tot}} ,$$
wherein “LF” represents a loading factor, “Nₜₒₜ” represents the total number of subcarriers, and “N_{used}” represents the number of used subcarriers among the total subcarriers.

9. The method as claimed in claim 1, wherein the base station calculates the data rate efficiency based on:
EDRᵢ=aᵢ×MCSᵢ×LFᵢ,
wherein “EDRᵢ” represents an effective data rate, “i” represents a loading factor index, “LFᵢ” represents an i^{th} loading factor, “aᵢ” represents a weight corresponding to the LFᵢ, and “MCSᵢ” represents an MCS corresponding to the LFᵢ.

10. The method as claimed in claim 9, wherein the weight aᵢ reflects a preference or priority of a corresponding loading factor region.

11. The method as claimed in claim 1, wherein the base station allocates to the mobile station a loading factor having a highest rate of the calculated effective data rates.

12. The method as claimed in claim 1, further comprising performing, by the base station, a frequency scheduling based on the loading factor allocated to the mobile station, after the base station allocates the loading factor to the mobile station.

13. The method as claimed in claim 1, further comprising controlling, by a controller superior to the base station, a size of each loading factor region at a predetermined interval with respect to all or some base stations based on the MCSs collected from each mobile station.

14. The method as claimed in claim 1, wherein each of the loading factors has a same frequency band regardless of base stations.

15. The method as claimed in claim 1, wherein each of the loading factors has different frequency bands according to the base stations.

16. The method as claimed in claim 1, wherein, when the loading factor has a value less than “1,” the base station configures a subchannel by pseudo randomly selecting subcarriers in a preset pattern.

17. The method as claimed in claim 1, wherein, when a reference signal simultaneously supporting a plurality of loading factors is configured, a transmission interval of the reference signal is set based on a coherent bandwidth.

18. The method as claimed in claim 1, wherein the mobile station transmits loading factors by using at least one selected from the group consisting of a scheme of transmitting MCSs for all loading factors at once, a scheme of transmitting MCSs for all loading factors one by one, and a scheme of transmitting a predetermined number of MCSs in a most preferable sequence one by one or at once.

19. The method as claimed in claim 1, wherein, when the base station notifies the mobile station of a predetermined weight corresponding to the loading factor, the mobile station directly calculates and feedbacks the effective data rate by using the predetermined weight.

20. The method as claimed in claim 19, wherein the mobile station transmits loading factors by using at least one selected from the group consisting of a scheme of transmitting the effective data rates for all loading factors at once, a scheme of transmitting the effective data rates for loading factors one by one, and a scheme of transmitting a predetermined number of effective data rates in a most preferable sequence either one by one or at once.

21. A system for allocating resources in a multi-cell communication system, the system comprising:
a mobile station for randomly feeding back Modulation and Coding Scheme (MCSs) corresponding to loading factors to a base station; and
a base station for transmitting a reference signal according to the loading factors to each mobile station, calculating efficient data rates corresponding to the MCSs fedback from the mobile station, selecting a loading factor based on the calculated effective data rates, and allocating resources to the mobile station according to the loading factor.

22. The system as claimed in claim 21, wherein the reference signal is transmitted in a pattern defined according to the loading factors, and a transmission interval of the reference signal and the pattern according to the loading factors are defined in the system in advance.

23. The system as claimed in claim 21, wherein each base station transmits the reference signal in an equal time/frequency domain.

24. The system as claimed in claim 21, wherein the loading factor refers to a ratio of a number of used subcarriers to the total number of subcarriers, and is expressed as:
$$LF = \frac{{n}_{used}}{{N}_{tot}} ,$$
wherein “LF” represents a loading factor, “Nₜₒₜ” represents the total number of subcarriers, and “N_{used}” represents the number of used subcarriers among the total subcarriers.

25. The system as claimed in claim 21, wherein the base station calculates the efficient data rate efficiency based on:
EDRᵢ=aᵢ×MCSᵢ×LFᵢ,
wherein “EDRᵢ” represents an effective data rate, “i” represents a loading factor index, “LFᵢ” represents an i^{th} loading factor, “aᵢ” represents a weight corresponding to the LFᵢ, and “MCSᵢ” represents an MCS corresponding to the LFᵢ.

26. The system as claimed in claim 25, wherein the weight aᵢ reflects a preference or priority of a corresponding loading factor region.

27. The system as claimed in claim 21, wherein the base station allocates the mobile station a loading factor having a highest rate of the calculated effective data rates.

28. The system as claimed in claim 21, wherein the base station allocates the loading factor to the mobile station and performs a frequency scheduling based on the loading factor allocated to the mobile station.

29. The system as claimed in claim 21, wherein a controller superior to the base station controls a size of each loading factor region at a predetermined interval with respect to all or some base stations based on the MCSs collected from each mobile station.

30. The system as claimed in claim 21, wherein each of the loading factors has a same frequency band regardless of base stations or different frequency bands according to the base stations.

31. The system as claimed in claim 21, wherein, when the loading factor is less than “1,” the base station configures a subchannel by pseudo randomly selecting subcarriers in a preset pattern.

32. The system as claimed in claim 21, wherein, when a reference signal simultaneously supporting a plurality of loading factors is configured, a transmission interval of the reference signal is set based on a coherent bandwidth.

33. The system as claimed in claim 21, wherein the mobile station transmits loading factors by using at least one selected from the group consisting of a scheme of transmitting MCSs for all loading factors at once, a scheme of transmitting MCSs for all loading factors one by one, and a scheme of transmitting a predetermined number of MCSs in a most preferable sequence either one by one or at once.

34. The system as claimed in claim 21, wherein, when the base station notifies the mobile station of a predetermined weight corresponding to the loading factor, the mobile station directly calculates and feedbacks the effective data rate by using the predetermined weight.

35. The system as claimed in claim 34, wherein the mobile station transmits loading factors by using at least one selected from the group consisting of a scheme of transmitting the effective data rates for all loading factors at once, a scheme of transmitting the effective data rates for loading factors one by one, and a scheme of transmitting a predetermined number of effective data rates in a most preferable sequence either one by one or at once.
